(19) United States
(12) Patent Application Publication
(10) Pub. No.: US 2022/0331622 A1
(43) Pub. Date: Oct. 20, 2022

(54) Passenger Oxygen Mask for Use in an Aircraft, Emergency Oxygen System, and Aircraft

(71) Applicant: B/E Aerospace Systems GmbH, Luebeck (DE)

(72) Inventor: Detlev Degenhardt, Stockelsdorf (DE)

(73) Assignee: B/E Aerospace Systems GmbH, Luebeck (DE)

(21) Appl. No.: 17/712,990

(22) Filed: Apr. 4, 2022

(30) Foreign Application Priority Data
Apr. 14, 2021 (EP) 21168366

(51) Int. Cl. A62B 18/02; A62B 7/14

(52) U.S. Cl. CPC A62B 18/025; A62B 7/14

(57) ABSTRACT

A passenger oxygen mask for use in an aircraft comprises a face piece defining a breathing space and having a proximal end, which is to be placed on the face of a user, and an opposite distal end; and a valve plate arranged at the distal end of the face piece. The valve plate is equipped with an oxygen port for an inflow of oxygen from an oxygen source into the breathing space; and an inlet valve for an inflow of ambient air into the breathing space. The valve plate has an elongated shape, having a longitudinal dimension in a longitudinal direction (L) and a transverse dimension, which is smaller than the longitudinal dimension, in a transverse direction (T).

### CROSS-REFERENCE TO RELATED APPLICATIONS

This application claims priority to, and the benefit of, EP Application No. 21168366.9, entitled “PASSENGER OXYGEN MASK FOR USE IN AN AIRCRAFT, EMERGENCY OXYGEN SYSTEM, AND AIRCRAFT,” filed on Apr. 14, 2021, which is hereby incorporated by reference in its entirety.

### FIELD

The present invention is in the field of aircraft equipment. In particular, the present invention is in the field of emergency equipment for aircraft. Further in particular, the present invention is in the field of passenger oxygen masks for use in aircraft

### BACKGROUND

All modern aircraft comprising a pressurized cabin are equipped with emergency oxygen masks, which are deployed for the passengers in case of a loss of cabin pressure during flight. The passenger oxygen masks are part of self-sustained emergency oxygen systems including oxygen sources that provide oxygen to the passengers in case cabin pressure is lost. The oxygen from the oxygen sources is supplemented with ambient air. The oxygen may be provided continuously or in oxygen pulses. Correct donning of the passenger oxygen masks is essential for ensuring their proper functionality and for providing the user of the oxygen masks with a sufficient amount of oxygen.

Accordingly, it would be beneficial to provide an improved passenger oxygen mask which allows to reduce the risk of an improper fit on a user's face.

### SUMMARY

Exemplary embodiments of the invention include a passenger oxygen mask for use in an aircraft, the passenger oxygen mask comprising a face piece and a valve plate. The face piece defines a breathing space and has a proximal end, which is to be placed on the face of a user, and an opposite distal end. The valve plate is arranged at the distal end of the face piece and is equipped with an oxygen port for an inflow of oxygen from an oxygen source into the breathing space and with an inlet valve for an inflow of ambient air into the breathing space. The valve plate has an elongated shape, with a longitudinal dimension in a longitudinal direction and a transverse dimension in a transverse direction. The transverse dimension is smaller than the longitudinal dimension. The oxygen port and the inlet valve are arranged along the elongated shape of the valve plate. The proximal end of the face piece has an elongated shape having a proximal longitudinal dimension in the longitudinal direction and a proximal transverse dimension, which is smaller than the proximal longitudinal dimension, in the transverse direction. The proximal end of the face piece of a passenger oxygen mask according to an embodiment of the present invention may, in particular have a substantially oval shape.

The shape of the face piece of a passenger oxygen mask according to an embodiment of the present invention, in particular the shape of the proximal end of the face piece of the passenger oxygen mask which is in contact with the user's face when the passenger oxygen mask has been donned by a user, is well fitted to the human face. As a result, the passenger oxygen mask may be applied to the user's face more easily and the risk of an improper donning is considerably reduced. In particular, the elongated shape of the proximal end of the face piece may be more intuitively placed over mouth and nose by the user. As compared to round face pieces, the risk of placing the face piece over only one of mouth and nose may be reduced.

In a passenger oxygen mask according to an embodiment of the present invention, the elongated shape of the valve plate corresponds to the elongated shape of the face piece. The long dimensions of the valve plate and the face piece may be substantially aligned. This may allow for storing the passenger oxygen mask in a space saving configuration, in which the face piece, or at least a portion of the face piece, is folded into a storage configuration having similar dimension as the valve plate. In consequence, the space needed for storing the passenger oxygen mask may be considerably reduced.

The passenger oxygen mask is configured for use in an aircraft. The passenger oxygen mask may in particular be an oronasal oxygen mask, i.e. an oxygen mask that is placed over the user's nose and mouth in case of an emergency. The valve plate and the face piece form a cup that can be placed over the user's nose and mouth and that form, together with the user's face, an enclosed space. It can also be said that the valve plate and the face piece jointly define a breathing space/breathing compartment, which is open to one side for being placed on the user's face. The face piece may also be referred to as mask wall.

The passenger oxygen mask may, in particular be an emergency oxygen mask, for example an emergency oxygen mask that drops from an overhead oxygen mask compartment of a passenger aircraft in case of pressure loss within the passenger cabin.

The valve plate and the face piece may be originally separate elements that are coupled together in a suitable manner, e.g. via gluing or welding. It is also possible that the valve plate and the face piece are an integral one-piece structure. For example, the valve plate and the face piece may be injection molded as a unitary/single piece. It is also possible that the face piece is molded onto the valve plate, e.g. via inter-molding/in-molding.

The valve plate and the face piece may be made from any material that is suitable for use in an oxygen mask employed in aircraft. For example, the valve plate and/or the face piece may be made from plastics material or rubber material or silicone material or any other suitable material for use in an aircraft oxygen mask. The valve plate and the face piece may be made from the same material. Alternatively, the valve plate and the face piece may be made from at least two different materials.

According to an embodiment, the passenger oxygen mask further comprises an outlet valve, which allows for a controlled outflow of air out of the breathing space. The oxygen port, the inlet valve and the outlet valve may be arranged along the elongated shape of the valve plate.

According to an embodiment, the oxygen port and the inlet valve are arranged next to each other in a linear or substantially linear configuration, which may be oriented in the longitudinal direction. If the passenger oxygen mask comprises the outlet valve, the oxygen port, the inlet valve and the outlet valve may be arranged next to each other in a linear or substantially linear configuration, which may be oriented in the longitudinal direction.

The oxygen port and the inlet valve may, in particular be arranged along a common line, which is oriented in the longitudinal direction. If the passenger oxygen mask comprises the outlet valve, the outlet valve may be arranged along said com-mon line as well. In this way, the transverse dimension of the valve plate may be kept low. This may help in folding the passenger oxygen mask in a particularly slim manner.

In an alternative embodiment, the oxygen port, the inlet valve and the outlet valve, if present, may be arranged along the elongated shape of the valve plate without being arranged on a common virtual line. Instead, one or any two or all of the oxygen port, the inlet valve and the optional outlet valve may be individually shifted to the left and/or right from the virtual line extending along the longitudinal direction.

According to an embodiment, the distal end of the face piece has an elongated shape with a distal longitudinal dimension in the longitudinal direction and a distal transverse dimension in the transverse direction, wherein the distal transverse dimension is smaller than the distal longitudinal dimension. A face piece with such a distal end may be easily attached to the valve plate.

In an alternative embodiment, the distal end of the face piece may be formed integrally with the valve plate.

According to an embodiment, the proximal longitudinal dimension of the face piece is larger than longitudinal dimension of the valve plate and/or the proximal trans-verse dimension of the face piece is larger than the transverse dimension of the valve plate. The proximal longitudinal dimension of the face piece may, in particular be larger than the distal longitudinal dimension of the face piece and/or the proximal transverse dimension of the face piece may be larger than the distal transverse dimension of the face piece.

Such a configuration may result in a conical shape of the face piece, having a larger proximal end and a smaller distal end. A large proximal end may allow for covering a large portion of a human face, in particular the nose and the mouth of a hu-man face. At the same time, the distal end of the face piece and the valve plate may have smaller dimensions than the proximal end of the face piece, which may allow for reducing the space needed for storing the passenger oxygen mask when not in use.

According to an embodiment, the proximal longitudinal dimension of the face piece is in the range of between 80 mm and 120 mm, in particular in the range of between 90 mm and 110 mm, more particularly in the range of between 95 mm and 105 mm. The proximal transverse dimension of the face piece may be in the range of between 70 mm and 100 mm, in particular in the range of between 80 mm and 90 mm, more particularly 85 mm.

Such dimensions of the proximal end of the face piece have been found to be well suited for fitting the proximal end of the face piece to a human face, in particular for fitting the proximal end of the face piece over mouth and nose in an intuitive manner.

According to an embodiment, the valve plate and/or the distal end of the face piece have a longitudinal dimension in the range of between 40 mm and 80 mm, in particular in the range of between 50 mm and 70 mm, more particularly a longitudinal dimension in the range of between 60 mm and 65 mm. The valve plate and/or the distal end of the face piece may further have a transverse dimension in the range of between 10 mm and 30 mm, in particular in the range of between 15 mm and 25 mm, more particularly a transverse dimension in the range of between 18 mm and 22 mm. A valve plate and/or a face piece having such dimensions may be conveniently stored in a small storing space.

According to an embodiment, the face piece has a distance between its distal end and its proximal end, which is in the range of between 30 mm and 70 mm, in particular in the range of between 40 mm and 60 mm, more particularly in the range of between 45 mm and 55 mm. Such dimensions of the face piece have been found to provide a good compromise between a good functionality and handling of the passenger oxygen mask and a small storing space needed for storing the passenger oxygen mask when not in use.

According to an embodiment, the face piece comprises a distal portion protruding from the valve plate and a proximal portion extending from a proximal end of the distal portion, opposite to the valve plate, towards the proximal end of the face piece. The proximal portion of the face piece may, in particular have a larger opening angle than the distal portion of the face piece. A large opening angle at the proximal end of the face piece may allow for covering a large portion of a user's face at a comparable small distance between the proximal end of the face piece and the valve plate, it may, in particular allow for simultaneously covering a user's nose and mouth in a convenient manner at a comparable small distance between the proximal end of the face piece and the valve plate. By additionally providing a distal portion of the face piece having a smaller opening angle, the volume of the face piece, in particular when arranged in a folded configuration, and the storing space needed for storing the passenger oxygen mask may be kept low.

According to an embodiment, the distal portion of the face piece is configured such that a distance between its proximal end and the distal end of the face piece in a direction, which is oriented perpendicularly to the plane of the distal end of the face piece, is in the range of between 10 mm and 30 mm, in particular in the range of between 15 mm and 25 mm, more particularly in the range of between 19 mm and 21 mm.

According to an embodiment, the proximal portion of the face piece is configured such that the distance between the proximal end of the face piece and the distal end of the proximal portion is in the range of between 20 mm and 40 mm, in particular in the range of between 25 mm and 35 mm, more particularly in the range of between 29 mm and 31 mm.

According to an embodiment, the proximal end of the distal portion of the face piece, opposite to the valve plate, has a transverse dimension in the range of be-tween 30 mm and 50 mm, in particular in the range of 35 mm to 45 mm, more particularly in the range of between 39 mm and 41 mm.

Such dimensions have been found to be a good compromise between providing a large proximal end of the face piece, which covers a large portion of a human face, and allowing the passenger oxygen mask to be stored in a small storing space.

According to an embodiment, the face piece comprises curved portions. The face piece may, in particular comprise four curved portions. Each curved portion may extend between a longitudinal side portion and a transverse side portion of the face piece, respectively.

According to an embodiment, the curved portions have a curvature radius in the range of between 30 mm and 50 mm, in particular a curvature radius in the range of between 35 mm and 45 mm, more particularly a curvature radius in the range of between 39 mm and 41 mm.

Such curved portions may allow for avoiding sharp edges at the corners of the face piece, which are prone to damage and which may cause injuries to the face of a user wearing the passenger oxygen mask.

According to an embodiment, the face piece comprises at least one bulge portion extending from a transverse side portion at the proximal end of the face piece. The at least one bulge portion may have an extension in the longitudinal direction in the range of between 3 mm and 15 mm, in particular an extension in the range of between 5 mm and 10 mm, more particularly an extension in the range of between 7 mm and 8 mm. The at least one bulge portion may further have an extension in the transverse direction in the range of between 10 mm and 30 mm, in particular an extension in the range of between 20 mm and 25 mm, more particularly an extension in the range of between 22 mm and 24 mm.

According to an embodiment, the at least one bulge portion is centered on a longitudinal central line extending centrally along the longitudinal direction of the face piece.

A bulge portion provided at the proximal end of the face piece may facilitate covering the nose of a user wearing the oxygen mask. As a result, the supply of oxygen to the user may be enhanced.

According to an embodiment, the face piece comprises two bulge portions extending from opposing transverse sides of the proximal end of the face piece. Such a configuration results in a symmetric shape of the proximal end of the face piece. A symmetric shape of the proximal end of the face piece may reduce the risk of donning the face piece in a non-intended orientation to the user's face, thus helping to provide the oxygen flow to the user in a desired manner.

According to an embodiment, the passenger oxygen mask further comprises an oxygen bag. The oxygen bag may, in particular be mounted to the valve plate and it may be fluidly connected to the oxygen port of the passenger oxygen mask. The oxygen bag may be made of a flexible gas-tight material, and it may comprise an oxygen inlet port for being fluidly coupled to the oxygen source in order to allow for supplying gaseous oxygen from the oxygen source into the oxygen bag.

Oxygen bags are usually employed in combination with oxygen sources which are configured for supplying a continuous flow of oxygen to the passenger oxygen mask. In such a configuration, the oxygen bag may act as an oxygen buffer by inflating and buffering the oxygen supplied by the oxygen source during time periods in which the user wearing the oxygen mask is not inhaling. When the user takes his/her next breath, the oxygen buffered within the oxygen bag is inhaled by the user. As a result, the oxygen bag is deflated before it is filled again with new oxygen supplied by the oxygen source.

Exemplary embodiments of the invention further include an aircraft emergency oxygen system comprising an oxygen source for supplying gaseous oxygen, and at least one passenger oxygen mask according to any of the embodiments described herein. The oxygen port of the at least one passenger oxygen mask is fluidly coupled to an outlet of the oxygen source. The additional features, modifications, and effects, described above with respect to the passenger oxygen mask, apply to the aircraft emergency oxygen system in an analogous manner.

According to an embodiment, the aircraft emergency oxygen system further comprises a control unit, which is configured for controlling the discharge of oxygen from the oxygen source to the at least one passenger oxygen mask.

The oxygen source may be configured for pulsed operation or for continuous operation. When configured for continuous operation, the oxygen source, when activated, supplies a continuous flow of oxygen to the passenger oxygen mask. When the oxygen source is configured for continuous operation, the passenger oxygen mask may be equipped with a flexible oxygen bag for buffering the continuous flow of oxygen, as it has been described before.

When configured for pulsed operation, the activated oxygen source supplies oxy-gen pulses to the passenger oxygen mask. In such an embodiment, the control unit is configured for synchronizing the oxygen pulses supplied to the at least one passenger oxygen mask with the inhaling of the user wearing the passenger oxygen mask. In particular, the control unit may be configured to use the inhaling of the us-er as a trigger for supplying an oxygen pulse. The inhaling may for example be detected via a suitable pressure sensor.

Exemplary embodiments of the invention also include an aircraft, such as an airplane or a helicopter, comprising at least one passenger oxygen mask according to an exemplary embodiment of the invention. Exemplary embodiments of the invention also include an aircraft, such as an airplane or a helicopter, comprising at least one aircraft emergency oxygen system according to an exemplary embodiment of the invention. The additional features, modifications, and effects, described above with respect to the passenger oxygen mask and the aircraft emergency oxygen system, apply to the aircraft in an analogous manner.

The aircraft emergency oxygen system may comprise a central oxygen source, which is configured for supplying oxygen to all passenger oxygen masks provided within the aircraft.

In an alternative configuration, the aircraft may comprise a plurality of aircraft emergency oxygen systems. In such a configuration, each aircraft emergency oxygen system comprises its own oxygen source and each aircraft emergency oxy-gen system is configured for supplying oxygen to a single passenger oxygen mask or to a group of passenger oxygen masks. A group of passenger oxygen masks may comprise between 2 and 20 passenger oxygen masks, in particular between 2 and 10 passenger oxygen masks. A group of passenger oxygen masks may in particular include a plurality of passenger oxygen masks assigned to a row or to a group of adjacent passenger seats within the aircraft.

### BRIEF DESCRIPTION OF THE DRAWINGS

Further exemplary embodiments of the invention are described below with respect to the accompanying drawings, wherein:

FIG. 1 shows an aircraft, in particular an airplane, in accordance with an exemplary embodiment of the invention in a schematic side view,

FIG. 2 shows a block diagram of an emergency oxygen system in accordance with an exemplary embodiment of the invention,

FIG. 3 shows a perspective view of a passenger oxygen mask in accordance with an exemplary embodiment of the invention,

FIG. 4 shows a perspective view of a passenger oxygen mask in accordance with another exemplary embodiment of the invention,

FIG. 5 shows a front view of a face piece, as may be used in a passenger oxy-gen mask according to an exemplary embodiment of the invention, and

FIG. 6 shows a cross-sectional view through the face piece of FIG. 5.

### DETAILED DESCRIPTION

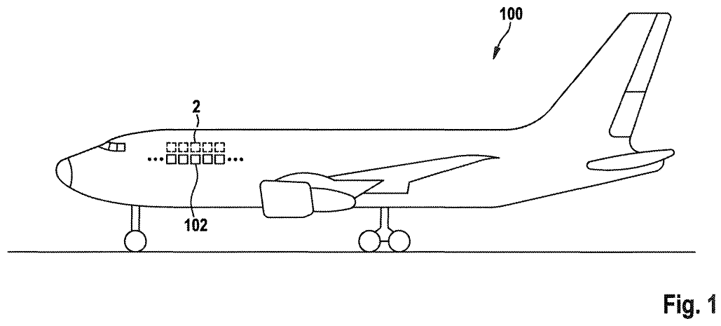

FIG. 1 shows an aircraft 100, in particular an airplane, in accordance with an exemplary embodiment of the invention in a schematic side view. In the exemplary embodiment shown in FIG. 1, the aircraft 100 is a large passenger airplane. It is possible that the aircraft 100 is a commercial passenger airplane, a private airplane, a military aircraft, or a rotorcraft, such as a helicopter.

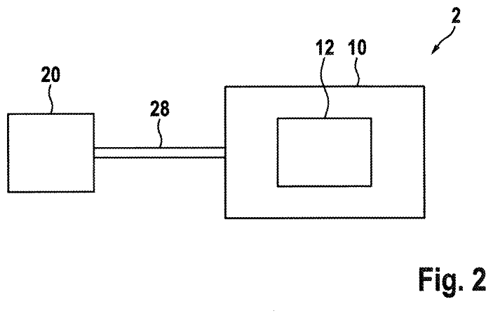

The aircraft 100 comprises a plurality of emergency oxygen systems 2, which may be embodied in accordance with the embodiment shown in FIG. 2.

FIG. 2 shows a block diagram of an emergency oxygen system 2 in accordance with an exemplary embodiment of the invention. The emergency oxygen system 2 comprises an oxygen source 10. The oxygen source 10 in turn comprises a control unit 12. The control unit 12 is configured for controlling the discharge of oxygen from the oxygen source 10 in operation. The emergency oxygen system 2 comprises a passenger oxygen mask 20, also referred to simply as oxygen mask 20 herein, that is coupled to the oxygen source 10 via an oxygen hose 28. While the oxygen source 10 is able to provide oxygen to a plurality of passenger oxygen masks, FIG. 2 depicts an exemplary situation where the oxygen source 10 is connected to a single oxygen mask 20.

Each row of seats of the aircraft 100 may have two emergency oxygen systems 2 associated therewith, one assigned to the seats on the left side of a center aisle and one assigned to the seats on the right side of the center aisle.

For the exemplary embodiment of each row of seats having six seats, every emergency oxygen system 2 may have one oxygen source 10 and three oxygen masks 20, coupled to the oxygen source 10. Such a set-up is schematically illustrated in FIG. 1 via five exemplary passenger windows 102, each being associated with a row of passenger seats, and via five exemplary emergency oxygen systems 2, depicted in phantom due to their arrangement within the aircraft 100.

The oxygen source 10 may be a continuous oxygen source 10, which, when activated, supplies a continuous stream of oxygen to the oxygen mask 20.

According to an alternative embodiment, the oxygen source 10 may be a pulsed oxygen source 10, which, when activated, supplies oxygen pulses to the oxygen mask(s) 20. In such an embodiment, the control unit 12 is configured for synchronizing the oxygen pulses, supplied to the at least one oxygen mask 20, with the breathing of the user wearing the oxygen mask 20.

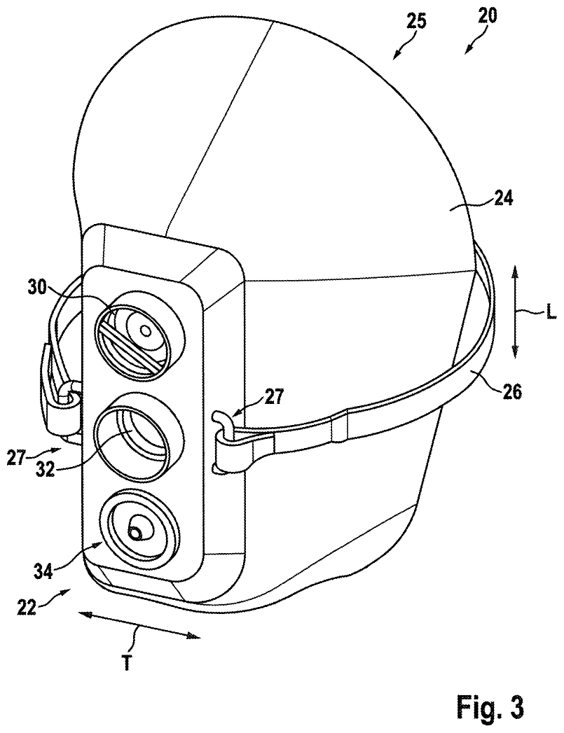

FIG. 3 shows a perspective view of a passenger oxygen mask 20 according to an exemplary embodiment of the invention.

The oxygen mask 20 comprises a valve plate 22 providing a base of the oxygen mask 20.

The oxygen mask 20 further comprises a face piece 24 and an elastic band 26. The elastic band 26 is fixed to the valve plate 22 via two mounting protrusions 27, extending from the valve plate 22.

The valve plate 22 comprises a front side, which is visible in FIG. 3, and an opposite rear side, which is not visible in FIG. 3. When the oxygen mask is positioned on a user's head, the rear side of the valve plate 22 is facing the user's head.

The face piece 24 protrudes from the read side of the valve plate 22 and defines a breathing space 25. Together, the valve plate 22 and the face piece 24 form a cup-like structure, whose interior is the breathing space 25. When using the oxygen mask 20, a user may place said cup over his/her nose and mouth and may fasten the oxygen mask 20 with respect to his/her head via the elastic band 26.

The valve plate 22 has an elongated shape having a longitudinal dimension in a longitudinal direction L and a transverse dimension, which is smaller than the longitudinal dimension, in a transverse direction T. When the oxygen mask 20 is donned by a user in its correct operational position, the longitudinal direction L extends basically vertically, i.e. in a direction extending from the chin towards the forehead of the user's head.

The valve plate 22 may, in particular have a rectangular shape. Alternative elongated shapes, such as elliptical shapes, are possible as well. In the embodiment depicted in FIG. 3, the valve plate 22 has a basically rectangular shape with rounded corners.

The oxygen mask 20 has an oxygen port 34 for an inflow of oxygen from an oxy-gen source 10 into the breathing space 25, an inlet valve 30 for an inflow of ambient air into the breathing space 25, and an optional outlet valve 32 for an outflow of air out of the breathing space 25.

When the oxygen mask 20 is installed as part of an emergency oxygen system 2, as it is depicted in FIG. 2, the oxygen port 34 is fluidly coupled to the oxygen source 10 via an oxygen hose 28, which is not shown in FIG. 3, in order to allow for supplying gaseous oxygen from the oxygen source 10 via the oxygen hose 28 and the oxygen port 34 into the breathing space 25.

The inlet valve 30 is a one-way valve, allowing ambient air to enter into the breathing space 25, where it mixes with the oxygen supplied from the oxygen source 10 forming an oxygen rich gas mixture, which is to be inhaled by the user of the oxy-gen mask 20.

The optional outlet valve 32 is a one-way valve, allowing gas exhaled by the user to leave the breathing space 25.

The oxygen port 34, the inlet valve 30 and the outlet valve 32 are located within and supported by the valve plate 22 in a configuration in which they are arranged along the elongated shape of the valve plate 22. The oxygen port 34, the inlet valve 30 and the outlet valve 32 may, in particular be arranged next to each other in a linear configuration, which is oriented along the longitudinal direction L.

The oxygen port 34, the inlet valve 30 and the outlet valve 32 may be arranged on a common virtual line extending along the longitudinal direction L. The common virtual line may, in particular extend along the center of the valve plate 22, when viewed along the transverse direction T.

In an alternative configuration, which is not explicitly shown in the figures, the oxygen port 34, the inlet valve 30 and the outlet valve 32 may be arranged along the elongated shape of the valve plate 22, without being arranged on a common virtual line. Instead, one or two or all of the oxygen port 34, the inlet valve 30 and the outlet valve 32 may be offset, in the transverse direction T, from a virtual line extending along the longitudinal direction L.

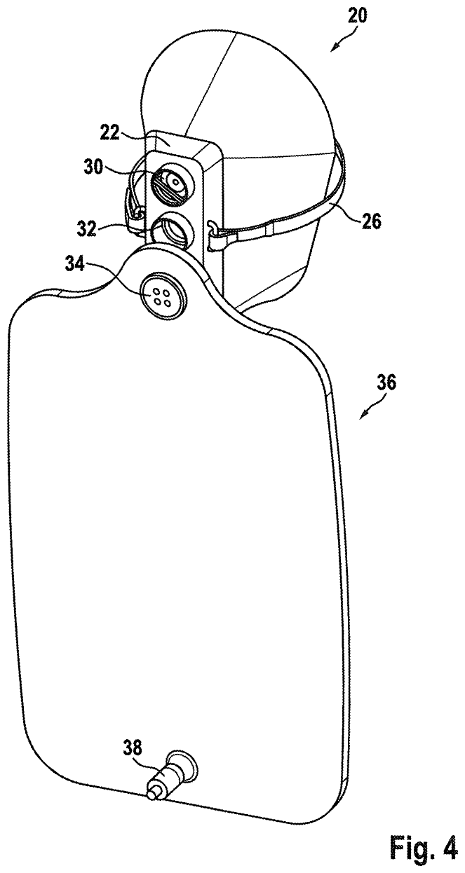

FIG. 4 shows a perspective view of a passenger oxygen mask 20 in accordance with another embodiment of the invention. The oxygen mask 20 of FIG. 4 has the features described with respect to FIG. 3 and additionally comprises an oxygen bag 36, mounted to the valve plate 22 and fluidly connected to the oxygen port 34.

The oxygen bag 36 is made of a flexible gas-tight material and comprises an oxygen inlet port 38. When an oxygen mask 20, as it is depicted in FIG. 4, is used as part of an emergency oxygen system 2, as it is depicted in FIG. 2, the oxygen inlet port 38 of the oxygen bag 36 is fluidly coupled to the oxygen source 10 via the oxygen hose 28, in order to allow for supplying gaseous oxygen from the oxygen source 10 via the oxygen hose 28, the oxygen bag 36 and the oxygen port 34 into the breathing space 25. The oxygen inlet port 38 may include a flow indicator for indicating whether a flow of gaseous oxygen is supplied via the inlet port 38 into the oxygen bag 36.

Oxygen masks 20 comprising oxygen bags 36, as depicted in FIG. 4, are usually employed in combination with oxygen sources configured for supplying a continuous flow of oxygen to the oxygen mask 20. In such a configuration, the oxygen bag 36 acts as an oxygen buffer by inflating and buffering the oxygen supplied by the oxygen source, while the user wearing the oxygen mask 20 is not inhaling. When the user takes his/her next breath, the oxygen buffered within the oxygen bag 36 is inhaled by the user. As a result, the oxygen bag 36 is deflated before it is filled again with new oxygen supplied by the oxygen source.

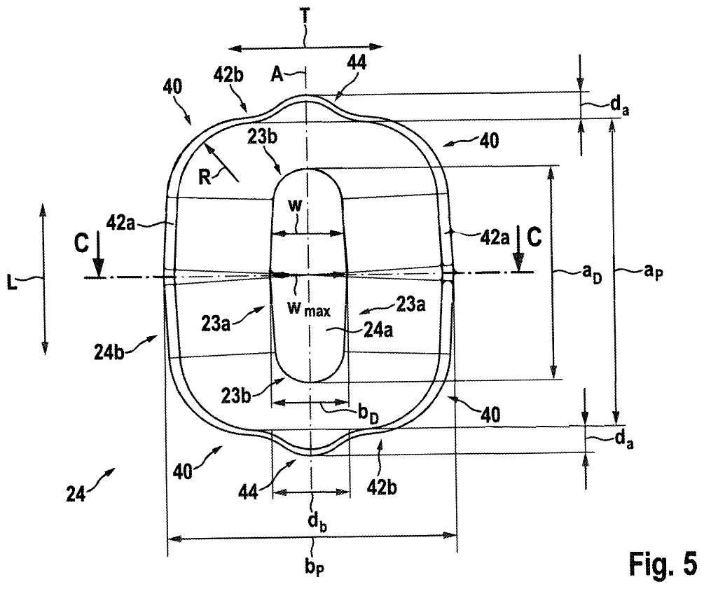

FIG. 5 shows a front view of a face piece 24 that may be used in a passenger oxygen mask 20 according to an exemplary embodiment of the invention. The viewing direction of FIG. 5 is orthogonal to the plane of the valve plate 22, which is not shown in FIG. 5. In other words, the viewing direction of FIG. 5 is orthogonal to the front of the face of a user wearing the oxygen mask 20.

The face piece 24 has a distal end 24a, which is mounted to the valve plate 22, and an opposite proximal end 24b, which abuts against the face of a user wearing the oxygen mask 20.

The distal end 24a, which is depicted in the center of FIG. 5, has an elongated shape having a distal longitudinal dimension a_{D} in the longitudinal direction L and a distal transverse dimension b_{D} in the transverse direction T. In particular, the distal end 24a has a shape which basically corresponds to the shape of the rear side of the valve plate 22. This allows to conveniently mount the distal end 24a of the face piece 24 to the valve plate 22. In an alternative embodiment, the distal end 24a of the face piece 24 may be formed integrally with the valve plate 22.

The distal transverse dimension b_{D} of the face piece 24 is smaller than its distal longitudinal dimension a_{D}(b_{D}<a_{D}).

The distal end 24a may have a longitudinal dimension a_{D} in the range of between 40 mm and 80 mm, in particular a longitudinal dimension a_{D} in the range of between 50 mm and 70 mm, more particular a longitudinal dimension a_{D} in the range of between 60 mm and 65 mm. The distal end 24a may further have a transverse dimension b_{D} in the range of between 10 mm and 30 mm, in particular a transverse dimension b_{D} in the range of between 15 mm and 25 mm, more particular a trans-verse dimension b_{D} in the range of between 18 mm and 22 mm.

In the embodiment depicted in FIG. 5, the transverse sides 23b of the distal end 24a have curved shapes, each of the transverse sides 23b of the distal end 24a may, in particular extend along a semicircle, extending between two opposite longitudinal sides 23a of the distal end 24a.

The longitudinal sides 23a of the distal end 24a may extend parallel to each other. In an alternative embodiment, the longitudinal sides 23a of the distal end 24a may be inclined with respect to each other so that the width of the distal end 24a along the transverse direction T varies along the longitudinal direction L. The longitudinal sides 23a of the distal end 24a may, in particular be inclined so that the distal end 24a has its maximum width wₘₐₓ at a central position, which is located at the center of the distal end 24a along the longitudinal direction L. In FIG. 5, a transverse line C-C extends through said central position.

The proximal end 24b, which in the sectional view depicted in FIG. 5 surrounds the distal end 24a, has an elongated shape having a proximal longitudinal dimension a_{P} in the longitudinal direction L and a proximal transverse dimension b_{P} in the transverse direction T, which is smaller than the distal longitudinal dimension a_{P}(b_{P}<a_{P}).

The proximal longitudinal dimension a_{P} of the face piece 24 may be in the range of between 80 mm and 120 mm, in particular in the range of between 90 mm and 110 mm. The proximal transverse dimension b_{P} of the face piece 24 may be in the range of between 70 mm and 100 mm, in particular in the range of between 80 mm and 90 mm, more particularly 85 mm.

The face piece 24 also comprises curved portions 40 resulting in a rounded contour, in particular in an oval contour, of the proximal end 24b of the face piece 24.

The face piece 24 may, in particular comprise four curved portions 40, wherein each of the curved portions 40 extends between a longitudinal side portion 42a and a transverse side portion 42b of the proximal end 24b of the face piece 24, respectively.

The curved portions 40 may have a curvature radius R in the range of between 30 mm and 50 mm, in particular a curvature radius R in the range of between 35 mm and 45 mm, more particularly a curvature radius R in the range of between 39 mm and 41 mm.

The face piece 24 may further comprise at least one bulge portion 44, protruding from a transverse side portion 42b of the proximal end 24b of the face piece 24. The at least one bulge portion 44 may, in particular be centered on a longitudinal central line A, extending centrally along the longitudinal direction L of the face piece 24.

The face piece 24 may comprise two bulge portions 44, extending from opposing transverse sides 42b of the proximal end 24b of the face piece 24, as depicted in FIG. 5.

The at least one bulge portion 44 may have an extension da in the longitudinal direction L, which is in the range of between 3 mm and 15 mm, in particular in the range of between 5 mm and 10 mm, more particularly in the range of between 7 mm and 8 mm. The at least one bulge portion 44 may have an extension d_{b} in the transverse direction T, which is in the range of between 10 mm and 30 mm, in particular in the range of between 20 mm and 25 mm, more particularly in the range of between 22 mm and 24 mm.

The extension d_{b} of the at least one bulge portion 44 in the transverse direction T may be identical with or different from the distal transverse dimension b_{D} of the distal end 24a.

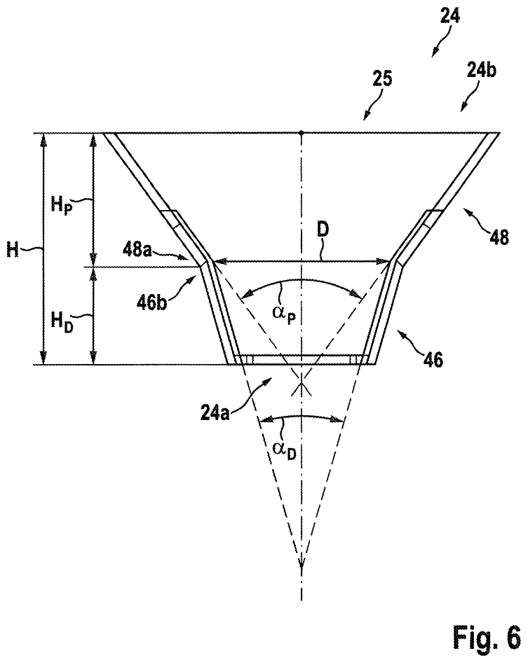

FIG. 6 shows a cross-sectional view through the face piece 24 of FIG. 5, with the depicted cross-sectional plane representing a cut along line C-C shown in FIG. 5.

The face piece 24 has a distance (height) H between its distal end 24a and its proximal end 24b, which may be in the range of between 30 mm and 70 mm, in particular in the range of between 40 mm and 60 mm, more particularly in the range of between 45 mm and 55 mm.

As depicted in FIG. 6, the face piece 24 may comprise a distal portion 46 and a proximal portion 48. The distal portion 46 includes the distal end 24a, which is arranged at the valve plate 22, which is not shown in FIG. 6, and protrudes from the distal end 24a towards a proximal end 46b of the distal portion 46. The proximal portion 48 extends from the proximal end 46b of the distal portion 46 towards the proximal end 24b of the face piece 24.

The distance HD between the distal end 24a of the face piece 24 and the proximal end 46b of the distal portion 46 may be in the range of between 10 mm and 30 mm, in particular in the range of between 15 mm and 25 mm, more particularly in the range of between 19 mm and 21 mm.

The distance HP between the proximal end 24b of the face piece 24 and the distal end 48a of the proximal portion 48 may be in the range of between 20 mm and 40 mm, in particular in the range of between 25 mm and 35 mm, more particularly in the range of between 29 mm and 31 mm.

The distal portion 46 of the face piece 24 may have a distal opening angle α_{D}, and the proximal portion 48 of the face piece 24 may have a proximal opening angle α_{P}, which is larger than the distal opening angle α_{D}(α_{P}>α_{D}).

The distal opening angle α_{D} may in particular be in the range of between 10° and 50°, in particular in the range of between 20° and 40°, more particularly in the range of between 30° and 36°.

The proximal opening angle α_{P} may in particular be in the range of between 50° and 90°, in particular in the range of between 60° and 80°, more particularly in the range of between 70° and 75°.

The proximal end 46b of the distal portion 46 of the face piece 24, which abuts the distal end 48b of the proximal portion 48, may have a transverse dimension D in the range of between 30 mm and 50 mm, in particular in the range of between 35 mm and 45 mm, more particularly a transverse dimension in the range of between 39 mm and 41 mm.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed, but that the invention will include all embodiments falling within the scope of the appended claims.

1. A passenger oxygen mask for use in an aircraft, comprising:
a face piece defining a breathing space and having a proximal end, which is to be placed on the face of a user, and an opposite distal end; and
a valve plate arranged at the distal end of the face piece and equipped with:
an oxygen port for an inflow of oxygen from an oxygen source into the breathing space; and
an inlet valve for an inflow of ambient air into the breathing space;
wherein the valve plate has an elongated shape, having a longitudinal dimension in a longitudinal direction (L) and a transverse dimension, which is smaller than the longitudinal dimension, in a transverse direction (T);
wherein the oxygen port and the inlet valve are arranged along the elongated shape of the valve plate; and
wherein the proximal end of the face piece has an elongated shape having a proximal longitudinal dimension (a_{P}) in the longitudinal direction (L) and a proximal transverse dimension (b_{P}), which is smaller than the proximal longitudinal dimension (a_{P}), in the transverse direction (T).

2. The passenger oxygen mask according to claim 1, further comprising an outlet valve for an outflow of air out of the breathing space, wherein the oxygen port, the inlet valve and the outlet valve are arranged along the elongated shape of the valve plate.

3. The passenger oxygen mask according to claim 1, wherein the proximal longitudinal dimension (a_{P}) of the face piece is larger than the longitudinal dimension of the valve plate and/or wherein the proximal transverse dimension of the face piece is larger than the transverse dimension of the valve plate.

4. The passenger oxygen mask according to claim 1, wherein the proximal longitudinal dimension (a_{P}) of the face piece is in the range of between 80 mm and 120 mm, in particular in the range of between 90 mm and 110 mm; and/or wherein the proximal transverse dimension (b_{P}) of the face piece is in the range of between 70 mm and 100 mm, in particular in the range of between 80 mm and 90 mm, more particularly 85 mm.

5. The passenger oxygen mask according to claim 1, wherein the longitudinal dimension of the valve plate is in the range of between 40 mm and 80 mm, in particular in the range of between 50 mm and 70 mm, more particularly in the range of between 60 mm and 65 mm; and/or wherein the transverse dimension of the valve plat is in the range of between 10 mm and 30 mm, in particular in the range of between 15 mm and 25 mm, more particularly in the range of between 18 mm and 22 mm.

6. The passenger oxygen mask according to claim 1, wherein the face piece has a distance (H) between its distal end and its proximal end in the range of between 30 mm and 70 mm, in particular in the range of between 40 mm and 60 mm, more particularly in the range of between 45 mm and 55 mm.

7. The passenger oxygen mask according to claim 1, wherein the face piece comprises a distal portion protruding from the valve plate and a proximal portion extending from a proximal end of the distal portion towards the proximal end of the face piece, and wherein the proximal portion of the face piece has a larger opening angle (α_{P}) than the distal portion.

8. The passenger oxygen mask according to claim 7, wherein the distal portion of the face piece has a distance (H_{D}) between its proximal end and the distal end of the face piece in the range of between 10 mm and 30 mm, in particular in the range of between 15 mm and 25 mm, more particularly in the range of between 19 mm and 21 mm.

9. The passenger oxygen mask according to claim 7, wherein the proximal end of the distal portion of the face piece has a transverse dimension (D) in the range of between 30 mm and 50 mm, in particular in the range of between 35 mm and 45 mm, more particularly a transverse dimension (D) in the range of between 39 mm and 41 mm.

10. The passenger oxygen mask according to claim 1, wherein the proximal end of the face piece has a substantially oval shape.

11. The passenger oxygen mask according to claim 1, wherein the face piece comprises curved portions, each curved portion extending between a longitudinal side portion and a transverse side portion of the face piece, respectively, wherein the curved portions in particular have a curvature radius (R) in the range of between 30 mm and 50 mm, more particularly a curvature radius (R) in the range of between 35 mm and 45 mm.

12. The passenger oxygen mask according to claim 1, wherein the face piece comprises at least one bulge portion extending from a transverse side portion at the proximal end (24b) of the face piece, wherein the bulge portion in particular has a longitudinal extension (dₐ) in the range of between 3 mm and 15 mm, more particularly in the range of between 5 mm and 10 mm, in the longitudinal direction (L), and/or a transverse extension (d_{b}) in the range of between 10 mm and 30 mm, more particularly in the range of between 20 mm and 25 mm, in the transverse direction (T).

13. The passenger oxygen mask according to claim 1, further comprising a flexible oxygen bag fluidly coupled to the oxygen port.

14. An aircraft emergency oxygen system, comprising:
an oxygen source, and
at least one passenger oxygen mask according to any of the preceding claims, wherein the oxygen port of the at least one passenger oxygen mask is fluidly coupled to the oxygen source,
wherein the oxygen source is in particular configured for continuously supplying oxygen to the at least one passenger oxygen mask, or wherein the oxygen source is in particular configured for supplying oxygen pulses to the at least one passenger oxygen mask.

15. An aircraft comprising passenger the oxygen mask according to claim 1.

16. An aircraft comprising the emergency oxygen system according to claim 14.
